(19) United States
(12) Patent Application Publication
(10) Pub. No.: US 2012/0052330 A1
(43) Pub. Date: Mar. 1, 2012

(54) PERPENDICULAR MAGNETIC RECORDING MEDIUM AND MANUFACTURING METHOD OF THE SAME

(75) Inventors: Ikuko TAKEKUMA, Tokyo (JP); Kimio NAKAMURA, Tokyo (JP); Junichi SAYAMA, Tokyo (JP); Hiroaki NEMOTO, Tokyo (JP)

(73) Assignee: HITACHI, LTD., Tokyo (JP)

(21) Appl. No.: 13/214,270

(22) Filed: Aug. 22, 2011

(30) Foreign Application Priority Data
Aug. 26, 2010 (JP) 2010-189545

(51) Int. Cl. G11B 5/66; G11B 5/84

(52) U.S. Cl. 428/829; 427/131

(57) ABSTRACT

A perpendicular magnetic recording medium having sufficient perpendicular uniaxial magnetic anisotropy energy and a crystal grain size for realizing an areal recording density of one terabit or more per one square centimeter, and excellent in mass productivity, and a manufacturing method of the same are provided. On a substrate, a substrate-temperature control layer, an underlayer and a magnetic recording layer are sequentially formed. The magnetic recording layer is formed by repeating a magnetic layer stacking step N times (N≧2), which includes a first step of heating the substrate in a heat process chamber, and a second step of depositing, in a deposition process chamber, the magnetic recording layer constituted of an alloy mainly composed of FePt to which at least one kind of non-magnetic material selected from a group constituted of C and an Si oxide is added.

### BACKGROUND OF THE INVENTION

1. Field of the Invention

The present invention relates to a perpendicular magnetic recording medium, and particularly relates to a magnetic recording medium having an areal recording density of one terabit or more per one square centimeter and a manufacturing method of the same.

2. Background Art

In order to realize a higher areal recording density while keeping thermal stability, a magnetic recording layer having high perpendicular uniaxial magnetic anisotropy energy Kᵤ is needed. An L1o-ordered FePt alloy is a material having high perpendicular uniaxial magnetic anisotropy energy Kᵤ as compared with an existing CoCrPt alloy, and is attracting attention as the material for next-generation magnetic recording layers (for embodiment, IEEE Trans. Magn., 36, p. 10, (2000)). In order to use the L1o-ordered FePt alloy as a magnetic recording layer, it is essential to reduce inter-granular exchange coupling, and in recent years, a number of attempts to realize the granular structure by adding a non-magnetic material such as SiO₂ to L1o-ordered FePt alloys have been reported as disclosed in JP 2008-91024 A and the like. Here, realizing the granular structure means making an FePt alloy have a structure constituted of magnetic crystal grains composed of FePt and crystal grain boundaries of a non-magnetic material which surround the magnetic crystal grains, and magnetically dividing the magnetic crystal grains. Since FePt has a disordered fcc structure as a metastable phase, ordering needs to be performed by heat treatment, and as the degree of ordering (ordering parameter) is higher, higher perpendicular uniaxial magnetic anisotropy energy is obtained. The heat treatment method for ordering is broadly classified into two that are 1) the method which heats a substrate before depositing an FePt alloy, or during deposition (preheat method), and 2) the method which heats a substrate after depositing an FePt alloy (post annealing method), and in recent years, it has been reported that in the case of use of a preheat method, a favorable granular structure with a high ordering parameter and a grain size of 10 nm or less has been obtained at a relatively low temperature (Appl. Phys. Lett., 91, p. 132506 (2007), J.

In many studies on an L1o-ordered FePt granular medium by a pre-heating method which have been disclosed so far, FePt alloys are deposited while the substrates are heated. At this time, deposition is performed while the substrates are being heated by the heaters which are placed on the back side of substrate, and therefore, the substrate temperature during deposition is constant. Meanwhile, when perpendicular magnetic recording media using an FePt granular film are produced (produced in volume) at a high speed, it is necessary to perform deposition on both sides of the substrates at the same time by using an in-line disk sputtering system. More specifically, since a heat process chamber and a deposition process chamber have to be separated, and heating cannot be performed during deposition, the substrate temperature during deposition lowers with a lapse of time. As the substrate temperature is higher, ordering of a FePT alloy advances more, and perpendicular uniaxial magnetic anisotropy energy becomes higher. When an FePt granular film is produced by a sputtering system for mass production, temperature reduction of the substrate occurs during deposition as described above, and therefore, unless the substrate temperature (substrate temperature immediately before deposition) in the heating chamber is made high as compared with the method which performs deposition while heating the substrate, an equivalent ordering parameter and perpendicular uniaxial magnetic anisotropy energy cannot be obtained. However, since the temperature at the time of formation of an initial layer becomes especially high at this time, there arises the problem that the crystal grain sizes become large. When an FePt granular medium is to be produced at a high speed like this, there arises the problem that it becomes more difficult to obtain a high ordering parameter and high perpendicular uniaxial magnetic anisotropy energy without making the grain diameters large.

JP 4-295626 A (1992) describes the method which reheats a substrate at each time of depositing a magnetic layer as the means which relieves reduction in the substrate temperature during deposition. However, the manufacturing method is a manufacturing method intended for a longitudinal magnetic recording medium using a CoCrPt media with Cr segregated structure, and its reheating temperature is 150 to 300° C., and is significantly low as compared with the temperature (350 to 600° C.) for ordering a FePt alloy. In general, as the substrate temperature is higher, and the heating time is longer, the crystal grain size increases more easily, but in the manufacturing method described in JP 4-295626 A (1992), increase in the crystal grain size by heating is not taken into consideration.

Further, when the doping amount of the material to be a grain boundary is increased to reduce the crystal grain size, there arises the problem of degrading the (001) texture quality as disclosed in Appl. Phys. Lett., 91, p. 132506 (2007).

### SUMMARY OF THE INVENTION

As described above, when an FePt granular medium is to be produced at a high speed, there arises the problem that it becomes more difficult to obtain a high ordering parameter and high perpendicular uniaxial magnetic anisotropy energy without making the grain diameters large. Further, when the addition amount of the material to be grain boundary is increased to reduce the crystal grain sizes, there arises the problem of degrading the (001) texture quality.

The present invention is made in view of these problems. More specifically, the present invention provides a perpendicular magnetic recording medium which has sufficient perpendicular uniaxial magnetic anisotropy energy and a crystal grain size for realizing an areal recording density of one terabit or more per one square centimeter and is excellent in mass productivity, and a manufacturing method of the same.

In order to attain the aforementioned object, according to one feature of the present invention, a perpendicular magnetic recording medium is manufactured by having the steps of forming a substrate-temperature control layer on a substrate, forming an underlayer on the substrate-temperature control layer, and forming a magnetic recording layer on the underlayer, wherein in the step of forming the magnetic recording layer, a magnetic layer stacking step is repeated N times (N≧2), which includes a first step of heating the substrate in a heat process chamber, and a second step of depositing a magnetic recording layer constituted of an alloy mainly composed of FePt to which at least one kind of a non-magnetic material selected from a group constituted of C and an Si oxide is added, in a deposition process chamber.

With use of the manufacturing method, the change of the substrate temperature during deposition of the magnetic recording layer can be made small, and even if the substrate temperature is set to be low as compared with the case of forming a magnetic recording layer at one time after heating the substrate, a high ordering parameter and perpendicular uniaxial magnetic anisotropy energy are obtained. As a result, the substrate temperature especially at the time of forming the initial layer of the magnetic recording layer becomes low, and therefore, the crystal grain size can be made small. Heating of the substrate is performed by a PBN (pyrolytic boron nitride) heater, laser, a lamp heater or the like installed in a vacuum chamber. Further, the content of the non-magnetic material which is added to the magnetic recording layer is changed in the film thickness direction, and in particular, the addition amount of the non-magnetic material included in the initial layer of the magnetic recording layer which controls the grain diameter is preferably made large.

The perpendicular magnetic recording medium produced by using the aforementioned manufacturing method of the perpendicular magnetic recording medium preferably satisfies relationships that (a total of a volume fraction of the non-magnetic material in a first magnetic recording layer)>(a total of a volume fraction of the non-magnetic material in a second magnetic recording medium), and (a total of a volume fraction of the non-magnetic material in an n^{th} magnetic recording layer)≧(a total of a volume fraction of the non-magnetic material in an (n+1)^{th} magnetic recording layer) (n≧2).

In general, as the volume fraction of the material to be a crystal grain boundary is higher, the crystal grain size can be made smaller. However, if the material to be the crystal grain boundary is excessively added, there arises the problem of degrading the (001) texture quality. We have found out that the crystal grain size of the magnetic recording layer in a FePt granular medium is significantly controlled by the total of the volume fractions of the materials to be the crystal grain boundary of the initial layer (in this case, the magnetic recording layer with a film thickness of 2 nm or less which is in contact with the underlayer is defined as the initial layer) of the magnetic recording layer, and that by increasing the volume fractions of the materials to be the crystal grain boundary of the initial layer, and decreasing the content of the crystal grain boundary materials from the initial layer to the upper layer, the crystal grain size can be reduced without degrading the (001) texture quality, as compared with the case of using the magnetic recording layer with the uniform volume fractions of the non-magnetic materials. Further, the total of the volume fractions of the non-magnetic materials in the first magnetic recording layer is preferably 25 vol. % to 40 vol. % inclusive. When the total of the volume fractions of the non-magnetic materials is smaller than the above described range, the crystal grain size becomes large to 7 nm or more, and the magnetic recording layer is not suitable as a high density magnetic recording medium. Further, when the volume fraction of the non-magnetic material is larger than the above described range, the (001) texture quality significantly degrades.

A film thickness of the first magnetic recording layer on an underlayer side configuring the magnetic recording layer is preferably 0.5 nm to 2 nm inclusive. If the film thickness of the first magnetic recording layer is set in this range, a higher (001) texture quality and a small crystal grain size can be realized without degrading the (001) texture quality. When the film thickness is smaller than the above described range, the effect of the reduction in the crystal grain size is small, and when the film thickness is larger than the above described range, the (001) texture quality degrades.

The substrate-temperature control layer is a layer with the purpose of increasing the heat capacity of the substrate without exerting an influence on the crystal textures of the underlayer and the magnetic recording layer to relieve temperature reduction during deposition of the magnetic recording layer. Accordingly, for the substrate-temperature control layer, a material which is difficult to crystallize even when heat treatment for ordering is performed, and a material inducing the crystal texture required for the underlayer need to be used. According to the present invention, the substrate-temperature control layer is preferably composed of Ni as a main component, and an amorphous material including at least one kind of element of Nb and Ta. Here, amorphous means the state in which a clear peak by X-ray diffraction is not observed, or the state in which a clear diffraction spot and diffraction ring by electron beam diffraction are not observed, and a halo-shaped diffraction ring is observed.

The addition amount of Nb added to the substrate-temperature control layer is desirably in the range of 20 at. % to 70 at. % inclusive, and the addition amount of Ta is desirably in the range of 30 at. % to 60 at. % inclusive. With the addition amounts outside the composition ranges, the (001) orientation qualities of the underlayer and the magnetic recording layer degrade, and therefore, the addition amounts outside the composition ranges are not preferable. Further, since Nb and Ta with high-melting points are added to the aforesaid material, the aforesaid material is difficult to crystallize even if heat treatment for ordering is performed, and even if the substrate-temperature control layer is formed with a thickness of several tens nm, the (001) orientation qualities of the underlayer and the magnetic recording layer are hardly influenced. More specifically, the heat capacity can be increased without impairing the (001) orientation quality, and reduction in the substrate temperature during deposition of the magnetic recording layer can be relieved. As a result, a smaller crystal grain size, and a high ordering parameter and perpendicular uniaxial magnetic anisotropy energy can be obtained.

Further, a material with Zr of 10 at. % or less added to an Ni—Nb alloy including Nb of 20 at. % to 70 at. % inclusive, or an Ni—Ta alloy including Ta of 30 at. % to 60 at. % inclusive may be used as the substrate-temperature control layer.

The substrate-temperature control layer is preferably made to have a thickness of 100 nm or more. As the film thickness of the substrate-temperature control layer is larger, the heat capacity of the substrate becomes larger, and reduction in the substrate temperature during deposition can be relieved. With the film thickness of 100 nm or more, an especially high ordering parameter and high perpendicular uniaxial magnetic anisotropy energy can be obtained.

Further, in accordance with necessity, the substrate-temperature control layer may be configured by a plurality of layers, and when a crystal material such as Cu is used as one of the layers, an Ni—Ta alloy or an Ni—Nb alloy is disposed on the crystal material, and thereby, a high ordering parameter and high perpendicular uniaxial magnetic anisotropy energy can be obtained without degrading the (001) texture quality. More specifically, at least the layer on the side in contact with the underlayer is preferably composed of an amorphous material including Ni as a main component, and including at least one kind of element of Nb and Ta. Further, by disposing an Ni—Ta alloy and Ni—Nb alloy on a top and a bottom of the crystal material, a favorable recording layer with small surface roughness can be formed.

According to the present invention, the magnetic recording layer is deposited by the method which repeats heating and deposition a plurality of times, and thereby, a high ordering parameter and a smaller crystal grain size can be realized without degrading the (001) texture quality.

### BRIEF DESCRIPTION OF THE DRAWINGS

FIG. 1A is a schematic sectional view of one embodiment of a perpendicular magnetic recording medium which is manufactured according to the present invention.

FIG. 1B is a schematic sectional view of another embodiment of the perpendicular magnetic recording medium which is manufactured according to the present invention.

FIG. 2 is a chart showing a manufacturing method of the perpendicular magnetic recording medium according to the present invention.

FIG. 3 is a diagram showing relationships between substrate temperatures and ordering parameters of perpendicular magnetic recording media of embodiment 1 of the present invention and a comparative embodiment.

FIG. 4A is a diagram showing a change of a substrate temperature during deposition of a magnetic recording layer.

FIG. 4B is a diagram showing changes of the substrate temperature during deposition of the magnetic recording layer.

FIG. 4C is a diagram showing a relationship of the number N of repetitions of heating and deposition and a substrate temperature at which a value of an ordering parameter S=0.85 or larger is obtained.

FIG. 5A is a diagram showing a relationship between a film thickness and (001) texture quality I₍₁₁₁₎/I₍₀₀₁₎ of a first magnetic recording layer.

FIG. 5B is a diagram showing a relationship between the film thickness and a crystal grain size of the first magnetic recording layer.

FIG. 6A is a diagram showing a relationship of (001) texture quality I₍₁₁₀₎/I₍₀₀₁₎ with respect to a volume fraction of C or SiO₂ which is added to the first magnetic recording layer.

FIG. 6B is a diagram showing a relationship of a crystal grain size with respect to the volume fraction of C or SiO₂ which is added to the first magnetic recording layer.

FIG. 7 is a diagram showing a relationship of I₍₁₁₀₎/I₍₀₀₁₎ with respect to fractions of Ta and Nb which are added to an Ni alloy of a substrate-temperature control layer.

FIG. 8 is a diagram showing a relationship of an ordering parameter with respect to a film thickness of the substrate-temperature control layer.

### DETAILED DESCRIPTION OF THE PREFERRED EMBODIMENTS

Hereinafter, an operational effect which the present invention brings about will be described based on several specific embodiments to which the present invention is applied, with reference to the drawings. These embodiments are described for the purpose of explaining a general principle of the present invention, and do not intend to limit the present invention in any way.

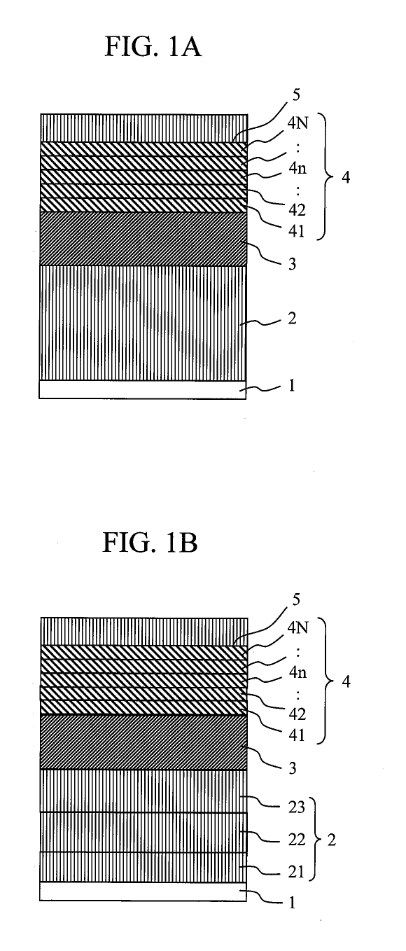

FIG. 1A is a schematic sectional view of one embodiment of a perpendicular magnetic recording medium according to the present invention. The perpendicular magnetic recording medium of the present embodiment has a structure in which a substrate-temperature control layer 2, an underlayer 3, a magnetic recording layer 4 and an overcoat layer 5 are sequentially formed on a substrate 1. The magnetic recording layer 4 is formed by sequentially stacking magnetic recording layers of N layers constituted of a first magnetic recording layer 41, a second magnetic recording layer 42, . . . , and an N^{th} magnetic recording layers in the deposition sequence.

For the substrate 1, various substrates with smooth surfaces can be used. For embodiment, a reinforced glass substrate, a crystallized glass substrate, an Si substrate and a thermally oxidized Si substrate can be used.

As the substrate-temperature control layer 2, an amorphous Ni alloy including Ni as a main component and at least one kind of element of Nb and Ta is used. The composition is determined so that Nb which is added to Ni is in the range from 20 at. % to 70 at. % inclusive, a Ta addition amount is in the range from 30 at. % to 60 at. % inclusive. Further, the composition in which Zr is added to an Ni—Nb alloy including Nb of 20 at. % to 70 at. % inclusive, or an Ni—Ta alloy including Ta of 30 at. % to 60 at. % inclusive may be used.

The underlayer 3 is used mainly for the purpose of controlling a crystal texture, a crystal grain size and the like of the magnetic recording layer. Accordingly, the material and the structure which are suitable for causing the L1o-ordered FePt alloy of the magnetic recording layer to have (001) texture can be used. For embodiment, a metal or an alloy including at least one kind of element of Ag, Au, Cu, Ir, Pt and Pd having an fcc structure, MgO of a B1 structure, Cr of a bcc structure, a Cr alloy such as RuCr or the like can be properly used. Further, as the underlayer, the underlayer constituted of a plurality of layers by combining these underlayers may be used.

For the magnetic recording layer 4, an alloy mainly composed of FePt to which at least one kind of non-magnetic material selected from A group constituted of C and an Si oxide is added is used. The magnetic recording layer is formed by stacking two magnetic recording layers or more which have different total contents of the non-magnetic materials constituted of A group, and the compositions of the respective magnetic recording layers are determined so as to satisfy the relationships of (the total volume fraction of the non-magnetic material selected from A group in the first magnetic recording layer)>(the total volume fraction of the non-magnetic material selected from A group in the second magnetic recording layer), and (the total volume fraction of the non-magnetic material selected from A group in the n^{th} magnetic recording layer)≧(the total volume fraction of the non-magnetic material selected from A group in the (n+1)^{th} magnetic recording layer) (n≧2). Here, the total volume fraction of the non-magnetic material selected from A group in the first magnetic recording layer is preferably 25 vol. % to 40 vol. % inclusive, and the film thickness of each of the magnetic recording layers which constitute the magnetic recording layer is set at 0.5 nm to 2 nm inclusive. Further, for the purpose of reducing the ordering temperature, elements constituted of Ag, Cu and Au may be added to the magnetic recording layer.

For the overcoat layer 5, for embodiment, a thin film having carbon as a main component with high hardness is used.

For formation of each of the layers which are stacked on the substrate 1 described above, various thin film formation techniques which are used for production of semiconductors, magnetic recording media, and optical recording media can be used. As the thin film formation technique, a DC magnetron sputtering method, an RF magnetron sputtering method, an MBE method and the like are well known. Among them, a sputtering method which is relatively high in film forming speed, can obtain a film with high purity irrespective of the material, and can control a microstructure and a film thickness distribution of a thin film by change of the sputter conditions (introduction gas pressure, discharge power) is preferable for mass production.

### Embodiment 1

A perpendicular magnetic recording medium the schematic sectional view of which is shown in FIG. 1A is produced. The perpendicular magnetic recording medium of the present embodiment is produced by using a Canon Anelva C-3010 in-line disk sputtering system. The present system is constituted by a plurality of process chambers for deposition, chambers exclusively for heating, and substrate load/unload chambers, and the respective chambers are independently evacuated. Before the perpendicular magnetic recording medium of the present embodiment is produced, all the chambers are evacuated to a degree of vacuum of 8×10⁻⁶ Pa or less. The processes are sequentially carried out by moving the carrier loaded with the substrate to the respective process chambers. Further, heating of the substrate is performed in the chamber exclusively for heating, and is performed from both sides of the substrate by using a PBN (Pyrolytic boron nitride) heater. The temperature rise rate of the heater is controlled by a PID, and the substrate is heated at about 10° C./sec in the present embodiment. Heating of the substrate is controlled based on the signal from a thermocouple which is attached to the front surface of the heater to optimize the temperature rise rate. The substrate temperature is measured by an infrared thermometer, and according to the measurement value, the temperature control value of the substrate heating is regulated. The value of the thermometer is amended so that the substrate temperature and the set temperature of the heater correspond to each other.

For measurement of the perpendicular uniaxial magnetic anisotropy energy Kᵤ, a torque magnetometer (TM-TRVSM5050-SM, made by Kabushikigaisha Tamakawa Seisakusho) is used. The magnetization curve is measured by applying a magnetic field of −50 kOe to 50 kOe in the direction perpendicular to the film. Kᵤ is obtained by using the value analyzed from the applied magnetic field (25 kOe, 50 kOe) dependency of the magnetic torque. For evaluation of the crystal texture quality, an x-ray diffractometer (XRD) (Smart Lab 9 kW) made by Rigaku Corporation is used. As the index expressing the degree of ordering, an ordering parameter S is used. The ordering parameter S shows the ratio of the number of atoms occupying the lattice points of an ideal ordered array, and is defined by the following expression.

$${S}^{2} = \frac{{[ {I}_{001} \text{/} {I}_{002} ]}_{experimental value}}{{[ {I}_{001} \text{/} {I}_{002} ]}_{theoritical value}}$$

I₀₀₁ and I₀₀₂ respectively indicate integrated intensities of a superlattice (001) peak and a fundamental (002) peak, and the theoretical values of I₀₀₁ and I₀₀₂ of the denominators are calculated from the structure factor, the atomic scattering factor, the Lorentz-polarization factor and absorption factor. S=1 shows an ideal ordered structure, and S=0 means a completely disordered structure. For analysis of the film compositions, a Fully automated XPS analysis equipment with scanning X-ray source (Quantera SXM) made by ULVAC-PHI is used.

The grain diameters of the crystal grains are evaluated according to the following method. Measurement of the crystal grain sizes is performed by observation of the crystal grain images by a transmission electron microscopy (TEM) and the image analysis. First, the magnetic recording medium specimen is cut out by about 2 mm from the disk and cut into small pieces. The small piece is polished, and an extremely thin film partially with only the magnetic recording layer and the overcoat layer is produced. The thin-film specimen is observed from the direction perpendicular to the substrate surface by using the transmission electron microscopy, and a bright-field crystal grain image is photographed. A bright-field image is an image formed by using only an electron beam which is not diffracted by shielding diffracted electron beams with an objective diaphragm of the electron microscopy. In the bright-field image of the granular medium, crystal grain portions appear as dark contrast portions since the diffraction intensity is high in the crystal grain portions, and grain boundary portions can be made the images clearly separated as bright contrast portions since the diffraction intensity is low in the grain boundary portions. In the bright-field image, the crystal grain images are obtained by drawing lines in the crystal grain boundary portion of the crystal grains having dark contrast. Next, the obtained crystal grain images are taken in a personal computer by a scanner and converted into digital data. The image data which is taken is analyzed by using commercially available grain analysis software, the numbers of pixels composing individual grains are obtained, and the areas of the individual grains are obtained from conversion of the pixels and the actual scales. The grain diameter is defined as the diameter of the circle having an area equal to the grain area which is obtained in advance. The measurement is performed for 300 grains or more, and the average grain diameter is defined as the arithmetic average of the obtained grain diameters.

Next, the method for measuring the grain boundary width of the magnetic recording layer will be described. The position of the center of gravity of each grain is obtained by commercially available grain analysis software. A line is drawn between the centers of gravity of the adjacent grains, and the length in the grain boundary portion is obtained in the number of pixels. The obtained length of the grain boundary portion is converted into an actual scale, the length of the grain boundary portion is obtained, and the lengths of 100 grain boundaries or more are arithmetically averaged, whereby the average grain boundary width is defined.

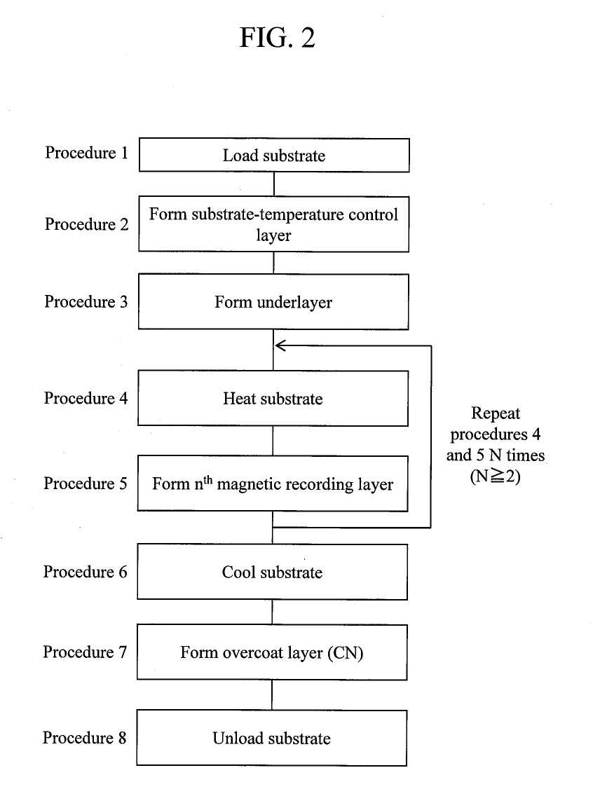

A flow of a manufacturing method of the present embodiment is shown in FIG. 2. The substrate-temperature control layer 2 and the underlayer 3 are formed on the substrate 1. Next, a procedure 4 of heating the substrate in the heat process chamber, and a procedure 5 of forming the n^{th} magnetic recording layer are repeated N times, and the n^{th} magnetic recording layer (n=1, 2, . . . , N) is formed in sequence. Hereinafter, deposition will be called N-step deposition according to the number N of repetitions in FIG. 2. In this embodiment, the samples are produced by 2-step deposition of N=2, and 4-step deposition of N=4. Next, after the substrate is cooled sufficiently to the temperature at which a diffusion reaction does not occur on the interface of the magnetic recording layer and the overcoat film, the overcoat film 5 is formed. As the substrate 1, an Si substrate with a thickness of 0.635 mm, and a diameter of 65 mm is used. As the substrate-temperature control layer 2, Ni-37.5 at. % Ta with a thickness of 100 nm is formed while as the underlayer 3, MgO with a thickness of 12 nm is formed. In this embodiment, the total film thickness of the magnetic recording layer 4 is fixed to 6 nm, and in the case of 2-step deposition, the film thicknesses of the first and the second magnetic recording layers are each made 3 nm, and in the case of 4-step deposition, the film thicknesses of the first to the fourth magnetic recording layers are each made 1.5 nm. In the present embodiment, each n^{th} magnetic recording layer (n=1, 2, . . . , N) is formed by using a target with C added by 34 at. % to (45.5 at. % Fe-45.5 at. % Pt-9 at. % Ag). At this time, the volume fraction of C is about 25 vol %.

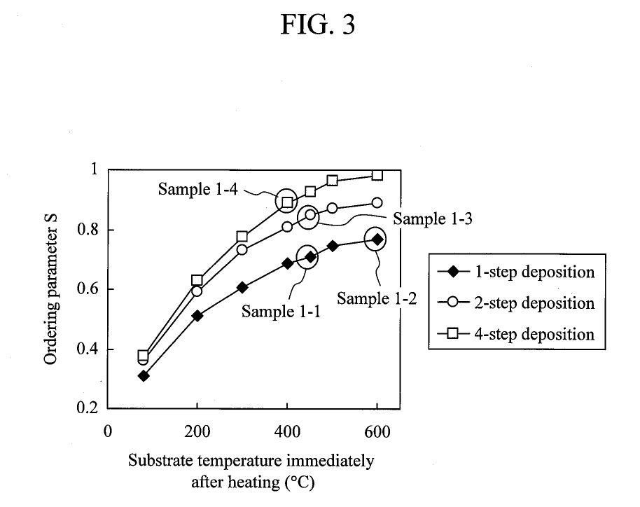

The overcoat film 5 is formed by performing sputtering in a mixture gas with nitrogen with gas pressure of 0.05 Pa added to argon with 0.6 Pa by using a carbon target, and the film thickness of carbon-nitrogen is 4 nm. In the present embodiment, the samples are produced by changing the substrate temperature from 80° C. to 600° C. Hereinafter, the substrate temperature means the substrate temperature which is measured immediately after heating is performed in the heat process chamber, and indicates the maximum achieved temperature of the substrate. At this time, heating is set to the same temperature each time, and heating is performed for two minutes in the heat process chamber. The change in the ordering parameter with respect to the substrate temperature (maximum achieved temperature of the substrate) immediately after heating of the produced sample is shown in FIG. 3. As a comparative example, an example (1-step deposition) in which a magnetic recording layer of 6 nm is formed at one time after the substrate is heated is also shown.

Comparing at the same substrate temperature, it is found out that higher ordering parameters are obtained when 2-step deposition is performed as compared with 1-step deposition, and when 4-step deposition is performed as compared with 2-step deposition. With respect to the typical samples shown in FIG. 3, the grain diameters and perpendicular uniaxial magnetic anisotropy energy Kᵤ of the magnetic recording layers are evaluated by using a transmission electron microscopy (TEM). The result is shown in Table 1. Table 1 also shows the substrate temperatures and the ordering parameters immediately after heating is finished.

TABLE 1

| Sample | Temperature | Ordering | Grain | |
|---|---|---|---|---|
| name | (° C.) | parameter | diameter (nm) | Ku (×10⁶ erg/cc) |
| 1-1 | 450 | 0.71 | 6.5 | 9 |
| 1-2 | 600 | 0.77 | 9.2 | 12 |
| 1-3 | 450 | 0.85 | 6.8 | 16 |
| 1-4 | 400 | 0.89 | 6.9 | 19 |

Comparing samples 1-1 and 1-2, in the case of 1-step deposition, when the substrate temperature is raised to 600° C. from 450° C., the ordering parameter becomes higher, but the crystal grain size significantly increases at the same time. Meanwhile, it is found out that in sample 1-3 of 2-step deposition, the ordering parameter and Kᵤ are higher than those of sample 1-2, and the grain diameter is smaller than that of sample 1-2. Further, in sample 1-4 of 4-step deposition, a higher ordering parameter and Kᵤ are obtained with substantially the same grain diameter as that of sample 1-3.

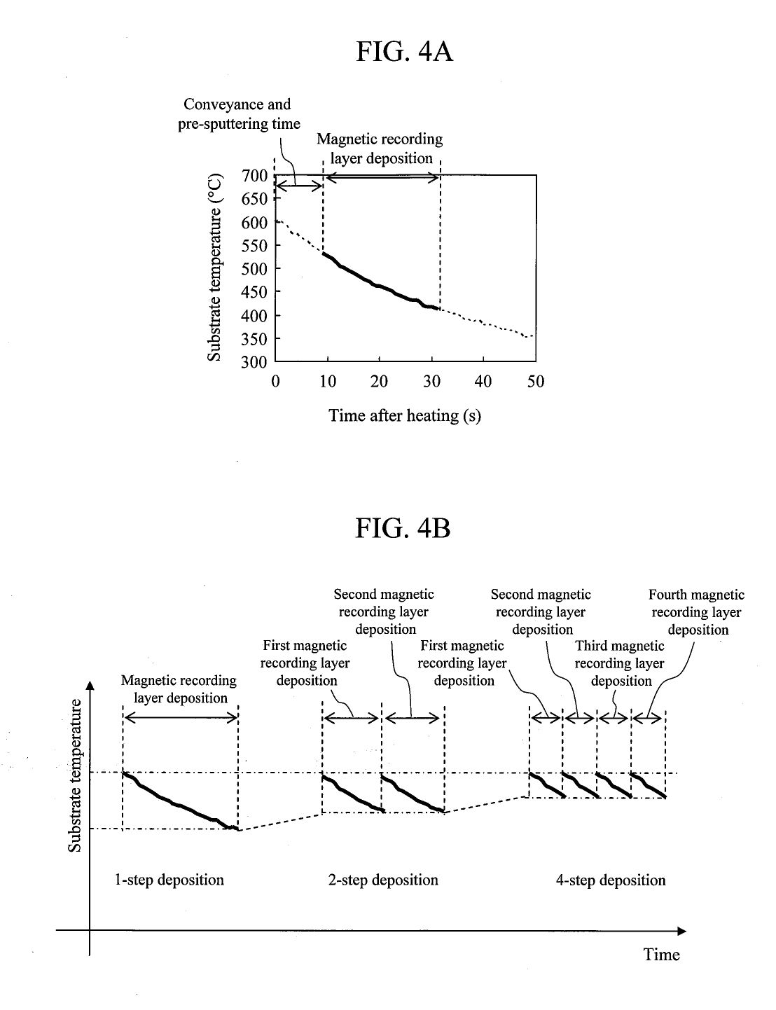

Hereinafter, the reason of the above will be described. In the case of an in-line disk sputtering system which can produce (mass production) media at a high speed, the heat process chamber and the deposition process chamber are separated, and therefore, after the substrate is discharged from the heat process chamber, the substrate temperature continues to lower. As an example, the measurement result of the substrate temperature after heating under the same conditions as in sample 1-2 is shown in FIG. 4A. The axis of abscissa of FIG. 4A represents a time after heating, which corresponds to the deposition time of the magnetic recording layer. It is found out that in the case of sample 1-2 in which the magnetic recording layer of 6 nm is deposited at one time, the temperature lowers by approximately 100° C. while the magnetic recording layer is deposited. Next, the substrate temperature changes in the case of 2-step deposition and 4-step deposition are shown in FIG. 4B. It is found out that by forming the magnetic recording layer divisionally while repeating heating and deposition instead of forming the recording layer at one time, the temperature reduction during deposition of the magnetic recording layer becomes smaller in 2-step deposition than in 1-step deposition, and in 4-step deposition than in 2-step deposition. It is considered that in 2-step deposition and 4-step deposition, high ordering parameters and perpendicular uniaxial magnetic anisotropy energy Kᵤ are obtained even when the substrate temperatures are made low since the temperature reduction during deposition is smaller as compared with 1-step deposition.

The production method shown in FIG. 2 can lower the substrate temperature for ordering as compared with 1-step deposition as the number of N is increased, and can especially lower the temperature at the time of formation of the initial layer. Since the crystal grain of the magnetic recording layer grows in the film thickness direction in accordance with the crystal grain size of the initial layer, reduction in the substrate temperature at the time of formation of the initial layer corresponds to reduction in the crystal grain size. As a result, it is conceivable that in the case of use of the production method (FIG. 2) shown in the present embodiment, a small grain diameter and high perpendicular uniaxial magnetic anisotropy energy are able to be obtained as compared with the case of performing 1-step deposition.

Next, the relationship of the number N of repetitions in FIG. 2 and the substrate temperature at which the value of an ordering parameter S=0.85 or larger can be obtained is shown in FIG. 4C. Here, as in samples 1-3 and 1-4, the total film thickness of the magnetic recording layer 4 is fixed to 6 nm, so that the film thickness of the n^{th} magnetic recording layer is determined to be equal in the case of each N. For example, in the case of N=6, each film thickness of the n^{th} magnetic recording layer is 1 nm. As shown in FIG. 4C, as the number of N is increased, the substrate temperature at which the value of the ordering parameter S=0.85 or larger is obtained lowers, but the substrate temperature is substantially saturated with N=4 or more, and in order to obtain the value of the ordering parameter S=0.85 or larger, heating at 350° C. or higher is needed. Accordingly, the heating temperature of the substrate is desirably 350° C. or higher.

### Embodiment 2

A perpendicular magnetic recording medium of the present embodiment is produced with the same film configuration and film conditions as in embodiment 1 except for the magnetic recording layer. In the present embodiment, the magnetic recording layer 4 is produced by 4-step deposition (N=4 in the deposition method shown in FIG. 2), the compositions of the first to the fourth magnetic recording layers are changed. Each of the thicknesses of the first to the fourth magnetic recording layers is 1.5 nm. Further, the samples are all produced with the condition of the heating temperature in the heat process chamber of 500° C., and the heating time is one minute.

Table 2 shows the result of evaluating the composition, the ordering parameter, the crystal grain size and the (001) texture quality of each of the magnetic recording layers of the produced samples. In Table 2, for example, when (45 at. % Fe-45 at. % Pt-10 at. % Ag)-30 at. % C (22 vol. % C) is described, the description means the composition in which C (carbon) is added to (45 at. % Fe-45 at. % Pt-10 at. % Ag) by 30 at. %, C is added by 22 vol. % when converted into a volume fraction. Evaluation of the (001) texture quality is made by the integrated intensity ratio I₍₁₁₁₎/I₍₀₀₁₎ of the FePt (001) diffraction peak and the FePt (111) diffraction peak in the X-ray diffraction profile. It can be determined as the value is smaller, the (001) texture quality is more excellent, and in this case, the one with the value of I₍₁₁₀₎/I₍₀₀₁₎ of less than 0.1 is set as rank a, and the one with that of 0.1 or more is set as rank b. Further, the reference of the grain diameter which can realize the areal recording density of one terabit or more per one square centimeter is set as 7 nm, the one with that of less than 7 nm is set as rank A, and the one with that of 7 nm or more is set as rank B. More specifically, in Table 2, the characteristic of the sample with the (001) texture quality rank of a, and the crystal grain size rank of A can be said as excellent.

TABLE 2

| Sample | First magnetic | Second magnetic | Third magnetic |
|---|---|---|---|
| number | recording layer | recording layer | recording layer |
| 2-1 | (45at. % Fe—45at. % Pt—10at. | (45at. % Fe—45at. % Pt—10at. | (45at. % Fe—45at. % Pt—10at. |
| | % Ag)—30at. % C(22vol. % C) | % Ag)—30at. % C(22vol. % C) | % Ag)—30at. % C(22vol. % C) |
| 2-2 | (45at. % Fe—45at. % Pt—10at. | (45at. % Fe—45at. % Pt—10at. | (45at. % Fe—45at. % Pt—10at. |
| | % Ag)—45at. % C(35vol. % C) | % Ag)—45at. % C(35vol. % C) | % Ag)—45at. % C(35vol. % C) |
| 2-3 | (45at. % Fe—45at. % Pt—10at. | (45at. % Fe—45at. % Pt—10at. | (45at. % Fe—45at. % Pt—10at. |
| | % Ag)—45at. % C(35vol. % C) | % Ag)—30at. % C(22vol. % C) | % Ag)—30at. % C(22vol. % C) |
| 2-4 | (45at. % Fe—45at. % Pt—10at. | (45at. % Fe—45at. % Pt—10at. | (45at. % Fe—45at. % Pt—10at. |
| | % Ag)—45at. % C(35vol. % C) | % Ag)—40at. % C(30vol. % C) | % Ag)—35at. % C(26vol. % C) |
| 2-5 | (45at. % Fe—45at. % Pt—10at. | (45at. % Fe—45at. % Pt—10at. | (45at. % Fe—45at. % Pt—10at. |
| | % Ag)—30at. % C(22vol. % C) | % Ag)—45at. % C(35vol. % C) | % Ag)—45at. % C(35vol. % C) |
| 2-6 | (45at. % Fe—45at. % Pt—10at. | (45at. % Fe—45at. % Pt—10at. | (45at. % Fe—45at. % Pt—10at. |
| | % Ag)—30at. % C(22vol. % C) | % Ag)—35at. % C(26vol. % C) | % Ag)—40at. % C(30vol. % C) |
| 2-7 | (46at. % Fe—46at. % Pt—8at. % Ag)—7 | (46at. % Fe—46at. % Pt—8at. % Ag)—7 mol. | (46at. % Fe—46at. % Pt—8at. % Ag)—7 mol. |
| | mol. % SiO2(20vol. % SiO2) | % SiO2(20vol. % SiO2) | % SiO2(20vol. % SiO2) |
| 2-8 | (46at. % Fe—46at. % Pt—8at. % Ag)—11.6 | (46at. % Fe—46at. % Pt—8at. % Ag)—11.6 | (46at. % Fe—46at. % Pt—8at. % Ag)—11.6 |
| | mol. % SiO2(30vol. % SiO2) | mol. % SiO2(30vol. % SiO2) | mol. % SiO2(30vol. % SiO2) |
| 2-9 | (46at. % Fe—46at. % Pt—8at. % Ag)—11.6 | (46at. % Fe—46at. % Pt—8at. % Ag)—7 | (46at. % Fe—46at. % Pt—8at. % Ag)—7 |
| | mol. % SiO2(30vol. % SiO2) | mol. % SiO2(20vol. % SiO2) | mol. % SiO2(20vol. % SiO2) |
| 2-10 | (46at. % Fe—46at. % Pt—8at. % Ag)—11.6 | (46at. % Fe—46at. % Pt—8at. % Ag)—10 | (46at. % Fe—46at. % Pt—8at. % Ag)—7 |
| | mol. % SiO2(30vol. % SiO2) | mol. % SiO2(27vol. % SiO2) | mol. % SiO2(20vol. % SiO2) |
| 2-11 | (45at. % Fe—45at. % Pt—10at. | (45at. % Fe—45at. % Pt—10at. | (46at. % Fe—46at. % Pt—8at. % Ag)—7 mol. |
| | % Ag)—45at. % C(35vol. % C) | % Ag)—40at. % C(30vol. % C) | % SiO2(20vol. % SiO2) |

| | | | | | (001) |
|---|---|---|---|---|---|
| | | Grain | | Grain | texture |
| Sample | Fourth magnetic | diameter | | diameter | quality |
| number | recording layer | (nm) | I₍₁₁₁₎/I₍₁₀₀₎ | rank | rank |
| 2-1 | (45at. % Fe—45at. % Pt—10at. | 9.3 | 0 | B | a |
| | % Ag)—30at. % C(22vol. % C) | | | | |
| 2-2 | (45at. % Fe—45at. % Pt—10at. | 6.1 | 0.27 | A | b |
| | % Ag)—45at. % C(35vol. % C) | | | | |
| 2-3 | (45at. % Fe—45at. % Pt—10at. | 6.5 | 0 | A | a |
| | % Ag)—30at. % C(22vol. % C) | | | | |
| 2-4 | (45at. % Fe—45at. % Pt—10at. | 6.0 | 0 | A | a |
| | % Ag)—30at. % C(22vol. % C) | | | | |
| 2-5 | (45at. % Fe—45at. % Pt—10at. | 7.7 | 0.07 | B | a |
| | % Ag)—45at. % C(35vol. % C) | | | | |
| 2-6 | (45at. % Fe—45at. % Pt—10at. | 8.1 | 0 | B | a |
| | % Ag)—45at. % C(35vol. % C) | | | | |
| 2-7 | (46at. % Fe—46at. % Pt—8at. % Ag)—7 mol. | 9.6 | 0 | B | a |
| | % SiO2(20vol. % SiO2) | | | | |
| 2-8 | (46at. % Fe—46at. % Pt—8at. % Ag)—11.6 mol. | 6.5 | 0.12 | A | b |
| | % SiO2(30vol. % SiO2) | | | | |
| 2-9 | (46at. % Fe—46at. % Pt—8at. % Ag)—7 mol. | 6.7 | 0 | A | a |
| | % SiO2(20vol. % SiO2) | | | | |
| 2-10 | (46at. % Fe—46at. % Pt—8at. % Ag)—7 mol. | 6.5 | 0 | A | a |
| | % SiO2(20vol. % SiO2) | | | | |
| 2-11 | (46at. % Fe—46at. % Pt—8at. % Ag)—7 mol. | 6.1 | 0 | A | a |
| | % SiO2(20vol. % SiO2) | | | | |

First, samples 2-1 and 2-2 are compared with each other. As the content of C (carbon) which is a non-magnetic material is increased, the crystal grain size decreases, but the (001) texture quality degrades. Thus, sample 2-3 in which the C addition amount is increased only in the first magnetic recording layer is produced. As a result, as compared with sample 2-2, the (001) texture quality is improved, and the crystal grain size is able to be made smaller than in sample 2-1. Further, a similar effect is seen by reducing the C content gradually from the first magnetic recording layer to the fourth magnetic recording layer, and in sample 2-4, the crystal grain size is able to be made small without degrading the (001) texture quality as compared with sample 2-2.

Meanwhile, when the C content is made high from the first magnetic recording layer to the fourth magnetic recording layer as in samples 2-5 and 2-6, the grain diameters are large as compared with those in samples 2-3 and 2-4. When an Si oxide is added as in samples 2-7 to 2-10, a similar effect to samples 2-1 to 2-4 is obtained. Further, the magnetic recording layers in which non-magnetic materials to be added are different may be combined as in sample 2-11, each layer is able to realize the crystal grain size smaller than those in samples 2-1 and 2-7 while keeping the ordering parameter and the (001) texture quality which are higher than those in samples 2-2 and 2-8. When the ordering parameters S are measured with respect to samples 2-3, 2-4, 2-9, 2-10 and 2-11, all of them indicate values not smaller than 0.9, and the perpendicular uniaxial magnetic anisotropy energy of each of them shows a high value of not smaller than 2.0×10⁷ erg/cc.

### Embodiment 3

A perpendicular magnetic recording medium of the present embodiment is produced with the same film configuration and deposition conditions as samples 2-3 and 2-4 of embodiment 2 except for the film thickness of the first magnetic recording layer.

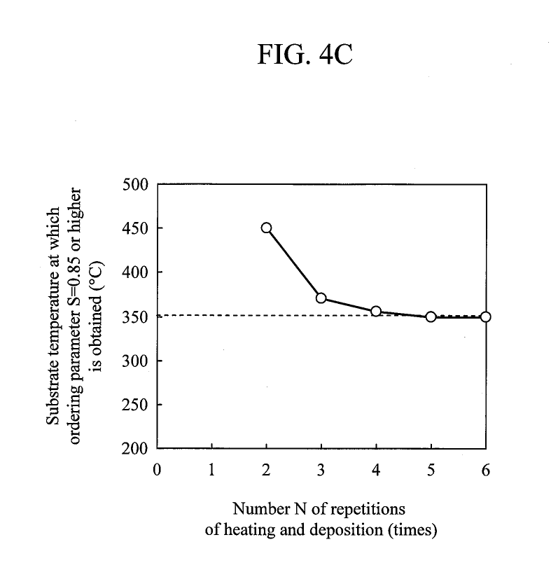

Sample series 3-1 of the present embodiment is a sample series in which the film thickness of the first magnetic recording layer of sample 2-3 of embodiment 2 is changed. Further, sample series 3-2 of the present embodiment is a sample series in which the film thickness of the first magnetic recording layer of sample 2-4 of embodiment 2 is changed. The X-ray diffraction of the produced sample series is measured, and the integrated intensity ratio I₍₁₁₀₎/I₍₀₀₁₎ of an FePt (001) diffraction peak and an FePt (111) diffraction peak is evaluated. Further, measurement of the crystal grain size is performed by using a TEM. The respective results are shown in FIGS. 5A and 5B.

It is found out that when the film thickness of the first magnetic recording layer is larger than 2 nm, the value of I₍₁₁₁₎/I₍₀₀₁₎ becomes significantly large, and the (001) texture quality degrades. Further, when attention is paid to the crystal grain size, it is found out that under the condition that the film thickness of the first magnetic recording layer is smaller than 0.5 nm, the grain diameter abruptly increases. From the above result, it can be said that the film thickness of the first magnetic recording layer is desirably 0.5 nm to 2 nm inclusive. When the non-magnetic material is SiO₂, a similar result is obtained, and when the film thickness of the first magnetic recording layer is changed with the same film configuration as in sample 2-9, for example, excellent (001) texture quality and the grain diameter of not more than 7 nm are obtained with the film thickness of 0.5 nm to 2 nm inclusive.

### Embodiment 4

Perpendicular magnetic recording media of the present embodiment are produced with the same film configuration and deposition conditions as in samples 2-3 and 2-9 of embodiment 2 except for the composition of the first magnetic recording layer.

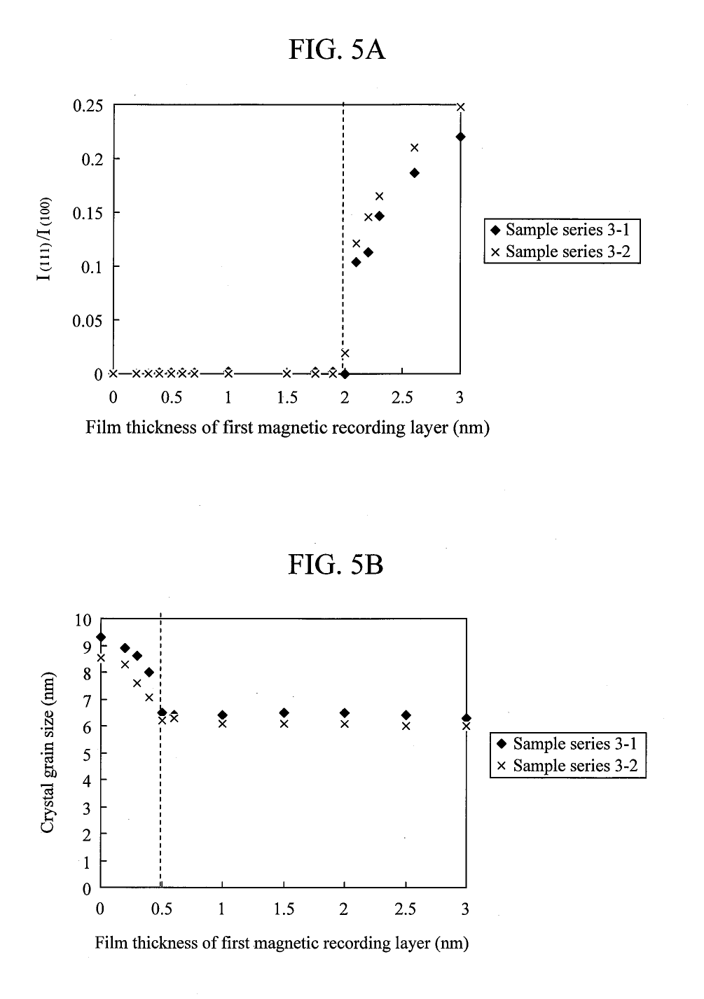

Sample series 4-1 of the present embodiment is a sample series in which the content of C added to the first magnetic recording layer of sample 2-3 of embodiment 2 is changed. Further, sample series 4-2 of the present embodiment is a sample series in which the content of SiO₂ added to the first magnetic recording layer of sample 2-9 of embodiment 2 is changed. The X-ray diffraction of the produced sample series is measured, and the integrated intensity ratio I₍₁₁₁₎/I₍₀₀₀₎ of the FePt(001) diffraction peak and the FePt(111) diffraction peak is evaluated. Further, measurement of the crystal grain size is performed by using a TEM. The respective results are shown in FIGS. 6A and 6B.

It is found out that when the content of C or SiO₂ added to the first magnetic recording layer is made larger than 40 vol. %, the value of I₍₁₁₁₎/I₍₀₀₁₎ abruptly becomes large, and the (001) texture quality degrades. Further, when attention is paid to the crystal grain size, as the content of C or SiO₂ added to the first magnetic recording layer is larger, the crystal grain size becomes smaller, and when the content of C or SiO₂ is smaller than 25 vol. %, the grain diameter becomes 7 nm or more, and this is not desirable as the medium which can realize the areal recording density of one terabit or more per one square centimeter. From the above result, the volume fraction of the non-magnetic material which is added to the first magnetic recording layer is desirably 25 vol. % to 40 vol. % inclusive.

### Embodiment 5

Perpendicular magnetic recording media of the present embodiment are produced with the same film configuration and deposition conditions as in sample 2-3 of embodiment 2 except for the substrate-temperature control layer.

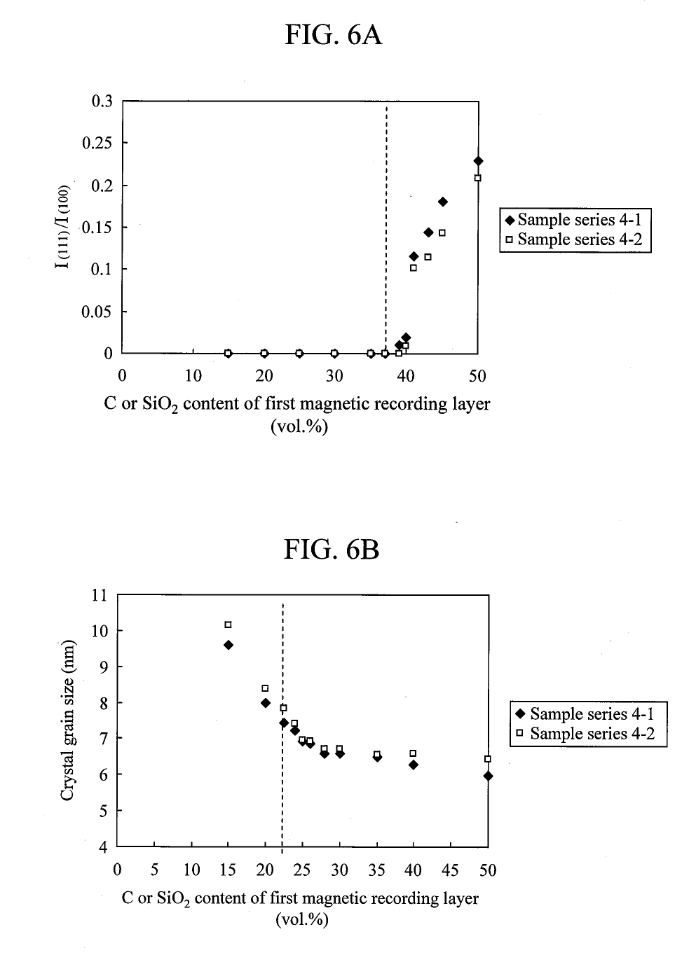

In this case, the samples with the addition amounts of Ta and Nb which are added to Ni of the substrate-temperature control layer being changed are produced, and the integrated intensity ratio I₍₁₁₁₎/I₍₀₀₁₎ of the magnetic recording layers is evaluated. The result is shown in FIG. 7. In the range of the Ta content of 30 at. % to 60 at. % inclusive and the Nb content of 20 at. % to 70 at. % inclusive, the intensity of the (111) peak becomes substantially zero, and a favorable (001) texture quality is obtained. Meanwhile, in the case outside the above described range, the substrate-temperature control layers are crystallized, and the (001) texture qualities of the underlayers and the magnetic recording layers degrade. Especially when the content of Ta is lower than 30 at. % and when the content of Nb is higher than 20 at. %, the (001) peak of the magnetic recording layer is hardly able to be confirmed. Further, when the content of Ta is higher than 60%, and when the content of Nb is higher than 70%, the (001) peak is able to be confirmed, but the (111) peak remains, and a favorable (001) texture quality is not able to be obtained.

From the above result, for an Ni alloy which is used as the substrate-temperature control layer, a composition in which Nb in the range of 20 at. % to 70 at. % inclusive and Ta in the range of 30 at. % to 60 at. % inclusive are added is desirably used.

### Embodiment 6

Perpendicular magnetic recording media of the present embodiment are produced with the same film configuration and deposition conditions as in sample 2-4 of embodiment 2 except for the substrate-temperature control layers.

In the present embodiment, the case is studied, in which the substrate-temperature control layer 2 is constituted of a plurality of layers. FIG. 1B is a schematic sectional view of the sample produced in the present embodiment. FIG. 1B shows an example, in which the substrate-temperature control layer 2 is constituted of a first substrate-temperature control layer 21, a second substrate-temperature control layer 22 and a third substrate-temperature control layer 23. Table 3 shows the configurations of the produced substrate-temperature control layers, the (001) texture qualities of the magnetic recording layers, and each value of an index Ra showing surface roughness measured by an atomic force microscope (AFM). Here, as the substrate-temperature control layers, amorphous NiTa and NiTaZr, and Cu which is a crystal material are studied. Since Cu has a high thermal conductivity, it is effective as a heat-sink layer when used in a thermally assisted magnetic recording.

TABLE 3

| | | Second substrate- | Third substrate- | | |
|---|---|---|---|---|---|
| Sample | First substrate-temperature | temperature | temperature control | | |
| number | control layer (nm) | control layer (nm) | layer (nm) | I₍₁₁₁₎/I₍₁₀₀₎ | Ra (nm) |
| 6-1 | Ni—37.5 at. % Ta (100) | — | — | 0 | 0.5 |
| 6-2 | Cu (100) | — | — | 100~ | 5.8 |
| 6-3 | Ni—37.5 at. % Ta (50) | Cu (50) | — | 100~ | 3.8 |
| 6-4 | Ni—37.5 at. % Ta (50) | Cu (50) | Ni—40 at. % Nb (50) | 0 | 0.8 |
| 6-5 | Ni—37.5 at. % Ta (50) | Cu (50) | Ni—37.5Ta at. % (50) | 0 | 0.7 |
| 6-6 | Ni—37.5 at. % Ta—5 at. % Zr (100) | — | — | 0 | 0.6 |
| 6-7 | Ni—40 at. % Nb—10 at. % Zr (100) | — | — | 0 | 0.6 |

In Sample 6-1 in which the substrate-temperature control layer is constituted of only NiTa which is an amorphous material, the (001) texture quality of the magnetic recording layer is favorable, and Ra is as small as 1 nm or less. Meanwhile, in the case of samples 6-2 and 6-3 in which crystal Cu is disposed directly under the underlayers 3, the (001) peak of FePt is not observed, and the (001) texture did not occur. This is because MgO of the underlayer has (111) texture on the Cu with (111) texture, and the magnetic recording layer on MgO also has (111) texture. Further, at this time, Ra also becomes very large. However, when amorphous NiTa and NiNb are formed on Cu as shown in samples 6-4 and 6-5, the (001) texture quality and the surface roughness are significantly improved. Further, when NiTaZr and NiNbZr are used instead of NiTa, a favorable (001) texture quality and Ra not larger than 1 nm are also obtained.

### Embodiment 7

Perpendicular magnetic recording media of the present embodiment are produced with the same film configuration and deposition conditions as in sample 2-4 of embodiment 2 except for the substrates, the substrate-temperature control layers and the underlayers.

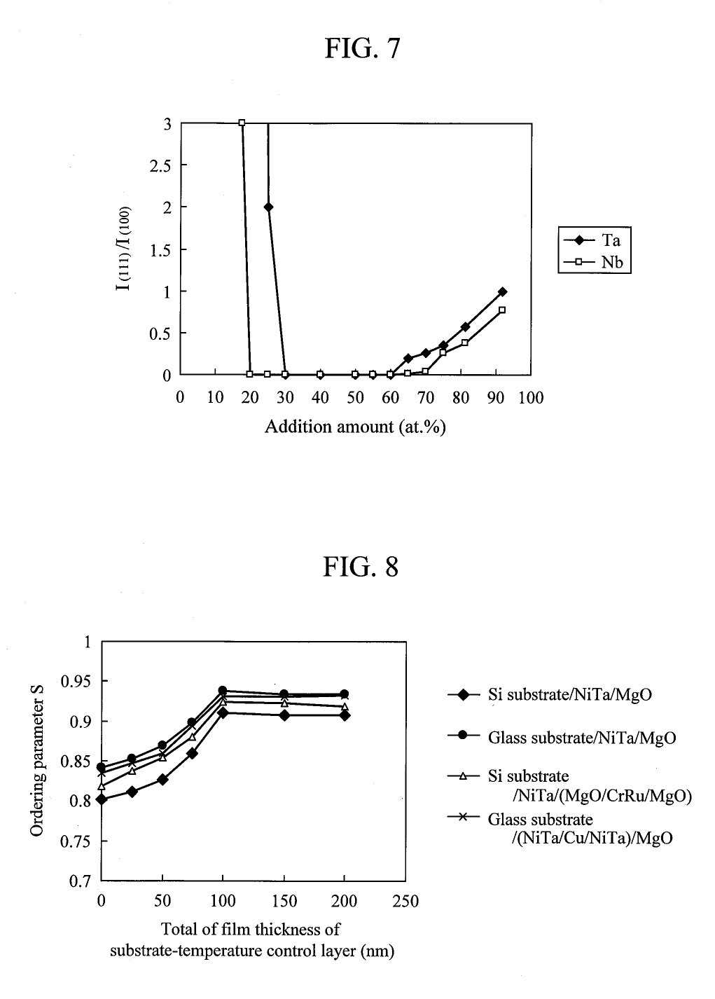

In the present embodiment, samples which have different film configurations of the substrates, the substrate-temperature control layers and the underlayers are produced, and the total of the film thicknesses of the substrate-temperature control layers is changed. FIG. 8 shows the changes in the ordering parameters with respect to the total film thicknesses of the substrate-temperature control layers in the case of using Ni-37.5 at. % Ta as the substrate-temperature control layer on the Si substrate, and MgO with a film thickness of 12 nm as the underlayer, in the case of using Ni-37.5 at. % Ta as the substrate-temperature control layer on a glass substrate, and MgO with a film thickness of 12 nm as the underlayer, in the case of using Ni-37.5 at. % Ta as the substrate-temperature control layer on the Si substrate, and the underlayer with MgO with a film thickness of 2 nm, Cr-10 at. % Ru with a film thickness of 30 nm and MgO with a film thickness of 10 nm being stacked in layer instead of an MgO underlayer with a film thickness of 12 nm, and in the case of using Ni-37.5 at. % Ta/Cu/Ni-37.5 at. % Ta as the substrate-temperature control layer on the glass substrate and MgO with a film thickness of 12 nm as the underlayer. However, in the case of using Ni-37.5 at. % Ta/Cu/Ni-37.5 at. % Ta as the substrate-temperature control layer, the total film thickness is changed with the ratio of the film thicknesses of 1:1:1.

As shown in FIG. 8, in each of the configurations, as the film thickness of the substrate-temperature control layer is larger, the ordering parameter becomes higher, and saturation occurs with the film thickness of 100 nm or more. When the substrate temperature during deposition of the magnetic recording layer is checked, it is found out that in each case, as the NiTa film thickness is made larger, the temperature reduction during deposition becomes smaller. This is conceivable to be because the thermal capacity of the substrate becomes large by forming the thick NiTa film on the substrate before deposition of the magnetic recording layer, and the temperature gradient of the substrate after the substrate is heated in the heat process chamber becomes small. However, in the case of the film thickness of the substrate-temperature control layer of 100 nm or more, the ordering parameter is hardly changed. Accordingly, in order to obtain a higher ordering parameter, the thickness of the substrate-temperature control layer is desirably 100 nm or more.

### DESCRIPTION OF SYMBOLS

1 SUBSTRATE
2 SUBSTRATE-TEMPERATURE CONTROL LAYER
3 UNDERLAYER
4 MAGNETIC RECORDING LAYER
5 OVERCOAT LAYER
21 FIRST SUBSTRATE-TEMPERATURE CONTROL LAYER
22 SECOND SUBSTRATE-TEMPERATURE CONTROL LAYER
23 THIRD SUBSTRATE-TEMPERATURE CONTROL LAYER
41 FIRST MAGNETIC RECORDING LAYER
42 SECOND MAGNETIC RECORDING LAYER
4n n^{TH} MAGNETIC RECORDING LAYER
4N N^{TH} MAGNETIC RECORDING LAYER

1. A manufacturing method of a perpendicular magnetic recording medium, comprising the steps of:
forming a substrate-temperature control layer on a substrate;
forming an underlayer on the substrate-temperature control layer; and
forming a magnetic recording layer on the underlayer,
wherein in the step of forming the magnetic recording layer, a magnetic layer stacking step is repeated N times (N≧2), which comprises a first step of heating the substrate in a heat process chamber, and a second step of depositing a magnetic recording layer comprising an alloy mainly composed of FePt to which at least one kind of a non-magnetic material selected from a group comprising C and an Si oxide is added, in a deposition process chamber.

2. A perpendicular magnetic recording medium produced by using the manufacturing method of the perpendicular magnetic recording medium according to claim 1,
wherein relationships that (a total of a volume fraction of the non-magnetic material in a first magnetic recording layer)>(a total of a volume fraction of the non-magnetic material in a second magnetic recording medium), and (a total of a volume fraction of the non-magnetic material in an n^{th} magnetic recording layer)≧(a total of a volume fraction of the non-magnetic material in an (n+1)^{th} magnetic recording layer) (n≧2) are satisfied.

3. The perpendicular magnetic recording medium according to claim 2,
wherein a film thickness of the first magnetic recording layer is 0.5 nm to 2 nm inclusive.

4. The perpendicular magnetic recording medium according to claim 2,
wherein a content of the non-magnetic material added to the first magnetic recording layer is 25 vol. % to 40 vol. % inclusive.

5. The perpendicular magnetic recording medium according to claim 2,
wherein at least a side in contact with the underlayer of the substrate-temperature control layer comprises an amorphous Ni—Nb alloy comprising Nb of 20 at. % to 70 at. % inclusive, or an amorphous Ni—Ta alloy comprising Ta of 30 at. % to 60 at. % inclusive.

6. The perpendicular magnetic recording medium according to claim 2,
wherein a total of a film thickness of the substrate-temperature control layer is 100 nm or more.
